(19) United States
(12) Patent Application Publication
(10) Pub. No.: US 2025/0214076 A1
(43) Pub. Date: Jul. 3, 2025

(54) AUTOMATIC PISTON-GRIPPING APPARATUS AND PIPETTE COMPRISING THE SAME

(71) Applicants: Mettler-Toledo (Changzhou) Measurement Technology Ltd., Changzhou (CN); Mettler-Toledo (Changzhou) Precision Instruments Ltd., Changzhou (CN); Mettler-Toledo International Trading (Shanghai) Co., Ltd., Shanghai (CN)

(72) Inventors: Weiguo Li, Changzhou (CN); Dawei Zhang, Changzhou (CN); Jianfei Xu, Changzhou (CN)

(21) Appl. No.: 18/850,110

(22) PCT Filed: Mar. 24, 2023
(86) PCT No.: PCT/CN2023/083795

§ 371 Date: Sep. 24, 2024

(30) Foreign Application Priority Data
Mar. 24, 2022 (CN) 202210295263.4

(51) Int. Cl. B01L 3/02

(52) U.S. Cl. CPC B01L 3/022; B01L 3/0279; B01L 2400/0478

(57) ABSTRACT

An automatic piston-gripping apparatus and a pipette including the same are disclosed. The apparatus includes a gripping mechanism, holding shank, first spring, and, optionally, piston. The gripping mechanism is arranged in the holding shank. The first spring sleeves over the gripping mechanism and is located between the gripping mechanism and holding shank. The apparatus is configured for inserting a piston from an end portion of the holding shank that faces a collet of the gripping mechanism. A locking ring is arranged at a head of the collet. The end portion of the holding shank includes a first limiting portion for positioning the locking ring. The collet extends out of the locking ring when the locking ring moves and/or moved to the first limiting portion and automatically grips the piston. The apparatus quickly and adaptively grips the piston, and an optionally produces a sound in the process thereof.

### BACKGROUND OF THE INVENTION

### Technical Field

The present invention relates to the field of liquid handling systems, and in particular to an automatic piston-gripping apparatus and a pipette comprising the same.

### Background Art

In the prior art, a piston-gripping mechanism is composed of a sleeve, a limiting member, a spring, and a collet. Usually, a collet, a sleeve, and a spring are used to assemble a gripping mechanism. The gripping mechanism grips a piston. The gripping mechanism of a pipette moves up and down to realize aspiration and dispensing of the desired amount of liquid. Wide variety of such liquid handling apparatuses or products can be used in scientific and industrial laboratories in application fields such as medicine, pharmacy, and molecular biology.

However, to realize gripping of the piston through the above-mentioned mechanism, a user needs to perform, a pre-operation of opening the collet in advance with an application of a certain amount of effort before the piston is loaded. Such operation has following problems: Firstly, it is inconvenient and laborious to load a piston; secondly, the piston may be damaged during its loading; and thirdly, it is not easy to observe whether gripping of the piston is successful.

In view of these problems, the inventor of the present invention has designed an automatic piston-gripping apparatus and a pipette comprising the same in order to overcome the forgoing technical problems.

### SUMMARY

The present invention provides an automatic piston-gripping apparatus and a pipette comprising the same, in order to overcome drawbacks of state-of-the-art piston-gripping mechanisms, which are inconvenient and laborious in operation and with which it is further easily to damage the piston during loading operation, and the like.

The present invention solves the above technical problem through the following technical solution: an automatic piston-gripping apparatus comprising a gripping mechanism, a holding shank, and a first spring, wherein the gripping mechanism is arranged, in particular movable arranged, in the holding shank, and the first spring sleeves over the gripping mechanism and is located between the gripping mechanism and the holding shank. The piston-gripping apparatus is configured for inserting a piston from an end portion of the holding shank that faces a collet, in particular a head of the collet, of the gripping mechanism, wherein a locking ring is arranged at a (the) head of the collet. The automatic piston-gripping apparatus is characterized by the end portion of the holding shank being provided with a first limiting portion for positioning the locking ring, and by the piston-gripping apparatus being configured for the collet, in particular the head of the collet, to extend (move) out of the locking ring when the locking ring moves and/or moved to the first limiting portion, and to automatically gripping the piston, in particular a piston rod.

According to an embodiment of the present invention, the gripping mechanism further comprises an adapter, a sleeve, and a second spring, wherein the adapter is arranged, in particular movably arranged, in the sleeve, the collet is mounted at an end portion of the adapter, and the second spring sleeves over the collet and is located between the collet and the sleeve.

According to an embodiment of the present invention, the locking ring sleeves over the head of the collet.

In many embodiments, the collet comprises at least two jaws. In these embodiments, the head of the collet is usually formed by the at least two jaws. The jaws are discussed in detail further below.

According to an embodiment of the present invention, the head of the collet is a petal-shaped structure.

According to an embodiment, the automatic piston-gripping apparatus comprises the piston. The piston, independent of whether it is comprised by the automatic piston-gripping apparatus may comprise a piston rod. The piston may further comprise a protrusion, in particular a protrusion on the piston rod, that is configured to interact with an element, for example a stop, of a tip loaded or to be loaded on the pipette that comprises the automatic piston-gripping apparatus.

According to a more specific embodiment of the present invention, a diameter of an internal gripping hole of the collet matches a diameter of a piston rod, this means of a piston to be used together with the automatic piston-gripping apparatus and the pipette comprising this apparatus.

According to an embodiment of the present invention, an inner wall surface of the holding shank is provided with a second limiting portion, an outer wall surface of the sleeve is provided with a third limiting portion, and two ends of the first spring respectively abut against the second limiting portion and the third limiting portion.

In particular, the first spring is a coil spring comprising exactly two ends. In this case, a first end may abut against the second limiting portion and a second end may abut against the third limiting portion.

According to an embodiment of the present invention, an inner wall surface of the sleeve is provided, in particular further provided, with a fourth limiting portion, and an end portion of the second spring abuts against the fourth limiting portion.

In particular, the second spring is a coil spring comprising exactly two ends. In this case, a first end may abut against the fourth limiting portion and a second end may be arranged to move with the collet, for example by abutting against a fifth limiting portion that may be, for example, a limiting portion formed by the collet or the adapter, if present.

In embodiments in which the collet comprises the at least two jaws, at least one of the following (i-iii) may apply:

i) The piston-gripping apparatus may be configured for inserting a piston from an end portion of the holding shank along a longitudinal axis, wherein the collet may comprise an elastic material that enables the jaws to move in a radial direction with respect to the longitudinal axis in reaction to a radial force applying on the jaws, wherein an opening between the jaws (111) may open or close due the radial movement of the jaws. The locking ring that is arranged at the head of the collet may generate such a radial force on the jaws, wherein an impact of the radial force generated by the locking ring on the jaws may depend on a relative position between the head of the collet, in particular the jaws, and the locking ring.

In a more specific embodiment, the piston-gripping apparatus may be configured for inserting a piston from an end portion of the holding shank along the longitudinal axis and for automatically gripping the piston by the head of the collet, in particular the jaws, and the locking ring being arrangeable in a first relative position of the head of the collet and the locking ring and in a second relative position of head of the collet and the locking ring, wherein in the first relative position the impact of the radial force generated by the locking ring on the jaws is such that the opening between the jaws is smaller than a (the) internal gripping hole of the collet, and wherein in the second relative position the impact of the radial force generated by the locking ring on the jaws is such that the opening between the jaws is larger than the internal gripping hole of the collet.

In particular, the longitudinal axis may be a longitudinal axis of the piston-gripping apparatus, the gripping mechanism and/or the pipette. The longitudinal axis may, and usually does, coincide with a longitudinal axis of the internal gripping hole of the collet.

The elastic material may be metallic.

At least the jaws may be made of the elastic material.

In the first relative position, the opening between the jaws may be closed. In other words, the jaws may be in contact in a region where the opening is formed.

It goes without saying that the first relative position cannot be taken and/or the size of the opening between the jaws in the first relative position is different from the size indicated above if a piston rod is present. In this case, however, the piston rod is clamped between the jaws if the head of the collet, in particular the jaws, and the locking ring are in the first relative position or in the relative position that is taken instead of the first relative position.

ii) The collet may comprise three jaws, the jaws being circularly arranged.

iii) The jaws each may have an end portion that is of a circular-arc vane type structure.

The present invention further provides a pipette, which is characterized by comprising the automatic piston-gripping apparatus according to any embodiment as described above.

The following are the positive and advanced effects of the present invention. According to the automatic piston-gripping apparatus and the pipette comprising same, the automatic piston-gripping apparatus can quickly and adaptively grip the piston, thereby solving the problem of a complicated operation of gripping the piston in an existing product or the prior art.

The automatic piston-gripping apparatus can produce a sound in the process of gripping the piston, indicating a successful gripping, thereby avoiding a faulty operation by the user.

### BRIEF DESCRIPTION OF THE DRAWINGS

The above mentioned features, properties and advantages of the present invention will become clearer on the basis of the description below in conjunction with the accompanying drawings and embodiments, and the features are denoted by the same reference numerals throughout the figures.

FIG. 1 is a schematic structural diagram of a gripping mechanism of the present invention.

FIG. 2 is a structural schematic diagram of an automatic piston-gripping apparatus of the present invention.

FIG. 3 is a structural schematic diagram of gripping a piston by an automatic piston-gripping apparatus of the present invention.

### DESCRIPTION OF EMBODIMENTS

To make the above objectives, features, and advantages of the present invention more apparent and easier to understand, embodiments of the present invention will now be described in detail. Reference will now be made in detail to preferred embodiments of the present invention, examples of which are illustrated in the accompanying drawings. The same reference numerals used in all the accompanying drawings denote identical or similar parts wherever possible.

Furthermore, although the terms used in the present invention are selected from well-known common terms, some of the terms mentioned in the description of the present invention may have been selected by the applicant according to his or her determination, and the detailed meaning thereof is described in the relevant section described herein.

Furthermore, the present invention must be understood, not simply by the actual terms used but also by the meaning encompassed by each term.

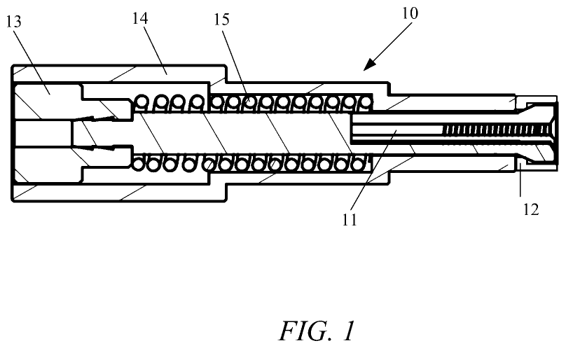

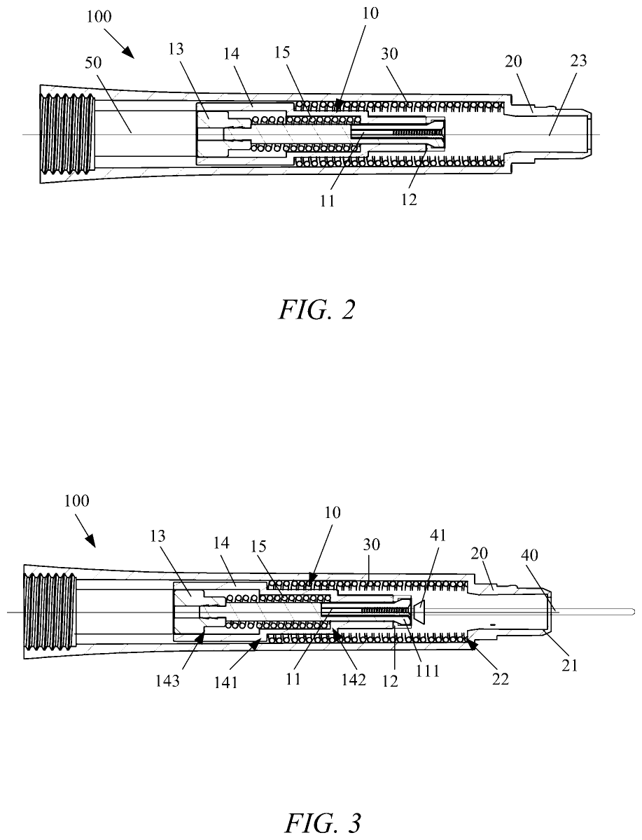

FIG. 1 is a schematic structural diagram of a gripping mechanism for an automatic piston-gripping apparatus that is in agreement with the present invention. FIG. 2 is a structural schematic diagram of an automatic piston-gripping apparatus that is in agreement with the present invention. FIG. 3 is a structural schematic diagram of gripping a piston by an automatic piston-gripping apparatus that is in agreement with the present invention.

As shown in FIG. 2 and FIG. 3, the present invention provides an automatic piston-gripping apparatus 100, which comprises a gripping mechanism 10, a holding shank 20, a first spring 30, and, as the case may be, a piston 40. The gripping mechanism 10 is arranged in the holding shank 20, and the first spring 30 sleeves over the gripping mechanism 10 and is located between the gripping mechanism 10 and the holding shank 20.

The piston 40 is inserted from an end portion of the holding shank 20 that faces a head of a collet 11 of the gripping mechanism 10. A locking ring 12 is arranged at the head of the collet 11, and an outer end portion of the holding shank 20 is provided with a first limiting portion 21 for positioning the locking ring 12. After the locking ring 12 moved to the first limiting portion 21, the collet 11 extends out of the locking ring 12 and automatically grips the piston 40.

Preferably, the gripping mechanism 10 further comprises an adapter 13, a sleeve 14, and a second spring 15 (also called spring 15 of the gripping mechanism, in the following), wherein the adapter 13 is arranged in the sleeve 14, the collet 11 is mounted at an end portion of the adapter 13, and the second spring 15 sleeves over the collet 11 and is located between the collet 11 and the sleeve 14.

The locking ring 12 preferably sleeves the head of the collet 11. The head of the collet 11 is a petal-shaped structure. A diameter of an internal gripping hole of the collet 11 matches a diameter of a piston rod of the piston 40.

Further, an inner wall surface of the holding shank 20 is provided with a second limiting portion 22, an outer wall surface of the sleeve 14 is provided with a third limiting portion 141, and two ends of the first spring 30 respectively abut against the second limiting portion 22 and the third limiting portion 141.

Preferably, an inner wall surface of the sleeve 14 is further provided with a fourth limiting portion 142, and an end portion of the second spring 15 abuts against the fourth limiting portion 142. A second end portion of the second spring 15 is configured to move with the collet 11. For example, the second end portion may be fixed to the collet 11, may abut against a protrusion of the collet 11 or the adapter 13, if present, may comprise a fifth limiting portion 143 against which the second end portion abuts.

Further preferably, the collet 11 comprises three jaws 111, the jaws 111 being circularly arranged. The jaws 111 each have an end portion that is of a circular-arc vane type structure.

The present invention further provides a pipette, which comprises the automatic piston-gripping apparatus as described above.

Based on the above structural description, in the automatic piston-gripping apparatus 100 of the present invention, the gripping mechanism 10 is arranged in the holding shank 20 at the lower end of the pipette. During operation, a user first inserts the pipette into a tip box to load a tip, presses down an operating handle of the pipette after the tip is loaded, and then releases the operating handle after hearing a “click” sound indicating a state of the automatic piston-gripping mechanism that guarantees a correct positioning and gripping of the piston 40. After the piston 40 in the tip was automatically griped by the gripping mechanism 10, the user can start to perform a conventional liquid transfer operation.

After completing the operation, the user presses down the operating handle to eject a tip assembly. After the tip assembly is ejected, the user releases the operating handle, and the gripping mechanism 10 returns to an initial position.

The following are working states of the automatic piston-gripping apparatus of the present invention.

The gripping mechanism 10 is in an initial state: the spring 15 in the gripping mechanism 10 acts as a spacer with a spring force N; the three jaws 111 at the head of the collet 11 are in a closed state; and in this state, a size of the end portion of the collet 11 may be smaller than an internal diameter of the locking ring 12.

The spring 15 in the gripping mechanism 10 holds the three jaws 111 at the head of the collet 11 in the locking ring 12. The locking ring 12 and the head of the collet 11 are in a first relative position in which, as mentioned above, the three jaws 11 at the head of the collet 11 are in a closed state. The spring 15 in the gripping mechanism 10 may be in a pre-loaded, compressed state. A movement of the collet 11 in a proximal direction, this means in a direction away from the end portion of the holding shank 20 from which the piston 40 is inserted and towards the main part of the pipette, the main part comprising the operating handle for example, may be limited. For example, the sleeve 14 may comprise a stop that limits the movement of the collet 11 in the proximal direction or the pipette may be configured to limit this movement, for example by limiting a movement of a pusher 50 in the proximal direction.

When a force is applied to the gripping mechanism 10, the first spring 30 is compressed into a compressed state: when the first spring 30 is in the compressed state, the spring force in the gripping mechanism 10 gradually increases from N; however, the three jaws 111 at the head of the collet 11 start to gradually open slightly due to a change of an impact of an acting force of the locking ring 12.

In particular, the acting force of the locking ring 12 on the three jaws 111 is a force that is radial with respect to a longitudinal axis 23 of the piston-gripping apparatus 100 and the gripping mechanism 10. The impact of this force may be considered as the extent to which this force allows the three jaws 111 to move radially away from the longitudinal axis 23, this means to open, or causes the three jaws 111 to move radially towards the longitudinal axis 23, this means to close.

The change of the impact of the acting force of the locking ring 12 on the three jaws 111 at the head of the collet 11, is due to a relative movement between the collet 11 and the locking ring 12.

In particular, the compressed state of the first spring 30 is given by the locking ring 12 abutting against a bottom of the holding shank 20, this means against the first limiting portion 21. The spring force in the gripping mechanism 10 is gradually increased from N by the spring 15 in the gripping mechanism 10 being compressed by the force applied to the gripping mechanism 10.

In particular, a spring constant of the first spring 30 (first spring constant) and a spring constant of the second spring 15 (second spring constant), this means of the spring 15 in the gripping mechanism 10, may be adapted to each other such that the second spring 15 is not compressed significantly by the force applied to the gripping mechanism 10 until the first spring 30 is in the compressed state. In particular, a spring force generated by the first spring 30 may be smaller than the spring force N in the initial state. In addition, the spring force generated by the first spring 30 may equalize or be higher than a spring force generated by the second spring 15 in the state of the gripping mechanism 10 in which the second spring 30 is in the compressed state.

In particular, the force is applied to the gripping mechanism 10 by the user, in particular by the user pressing down an operating handle of the pipette. During pressing down the operating handle, the user may held a housing of the pipette, said housing comprising the holding shank 20, such that a relative movement between the operating handle, and elements connected to the operating handle, and the housing, and elements connected to the housing, occurs.

In particular, the force is applied to the gripping mechanism 10 by a pusher 50 acting on a central region of a proximal side of the gripping mechanism 10. In particular, the central region does not comprise a proximal face of the sleeve 14. In embodiments comprising the adapter 13, the pusher 50 may act on the adapter 13, in particular on the adapter 13 only.

When the locking ring 12 moves to the bottom of the holding shank 20, the three jaws 111 of the collet 11 may open gradually to an inner wall of the locking ring 12, and to the diameter of the internal gripping hole of the collet 11 that matches the diameter of the piston rod of the piston.

The collet 11 releases from the locking ring 12 to move to a position flush with the bottom of the holding shank 20. The collet 11 continues to move forward, while the locking ring 12 remains at the bottom of the holding shank 20. In this state, the size of the end portion of the collet 11 may be equal to the internal diameter of the locking ring 12 and a size of an outer circle of the head of the collet 12.

The collet 11 releases further from the locking ring 12 by the collet 11 continuing to move forward to leave the bottom of the holding shank 20, wherein the locking ring 12 is then affected by an expansion elastic force of the jaws 111 of the collet 11, and starts to move backward to leave the bottom of the holding shank 20 while a sound of impact is generated. In this state, the size of the end portion of the collet 11 is equal to an outer circle diameter of the jaws 111 that are fully opened. The locking ring 12 and the head of the collet 11 are in a second relative position in which, as mentioned above, the three jaws 11 at the head of the collet 11 are fully opened.

In this state and in all previous states in which the three jaws 111 are open at least to the diameter of the internal gripping hole of the collet 11 that matches the diameter of the piston rod of the piston 40, the piston rod can move freely along the internal gripping hole of the collet 11 and/or can be pushed along the internal gripping hole of the collet 11. This allows the piston 40 to assume a relative position with respect to the tip that is given by a stop of the tip in case the tip is loaded on the pipette already. For example, the piston 40 may move out of the gripping mechanism 10 until a protrusion 41 of the piston 40 abuts against a stop of the tip. This relative position may be the position needed for starting to perform a liquid transfer operation. In case the tip is not yet loaded on the pipette already, the opportunity for said movement and/or pushing allows for easy insertion of the piston 40 into the automatic piston-gripping apparatus.

The sound of impact may be considered as a hint to the user that the automatic piston-gripping apparatus 100 reaches a state that guarantees correct gripping and, as the case may be, positioning of the piston 40 and that it is time now to release the operating handle. Gripping of the piston 40 is triggered by the release of the operating handle and the corresponding reduction of the force that applies to the gripping mechanism 10. This reduction allows the spring 15 in the gripping mechanism 10 to release and hence to retract the collet 11, in particular the three jaws 111, into the locking ring 12. Thereby, the impact of the acting force of the locking ring 12 on the collet 11, in particular on the three jaws 111, increases and the opening between the three jaws 11 closes, whereby the piston 40 is gripped.

In case the tip is loaded already on the pipette, the liquid transfer operation can then be carried out by the user in any manner that is appropriate for the pipette used.

After completing the liquid transfer operation, the tip, and usually also the piston 40, is (are) ejected from its (their) position on (in) the pipette. Therefore, the force is applied again to the gripping mechanism 10 such that the locking ring 12 moves to the bottom of the holding shank 20 and the collet 11 leaves the bottom of the holding shank to an extend that it generates an ejecting force on the tip. For example, the protrusion 41 may be pressed against the tip, for example against the stop of the tip, with a force that causes ejection of the tip. Since the jaws 111 are fully open in this state of the collet 11, the piston 40 is ejected as well or it can be easily removed from automatic piston-gripping apparatus.

In particular, the tip, and usually also the piston 40, is (are) ejected: the collet 11 moves forward to leave the bottom of the holding shank 20, and then an end face of the piston 40 is pushed out by the collet 11 and the tip and the piston are ejected.

In conclusion, according to the automatic piston-gripping apparatus and the pipette comprising the same, the automatic piston-gripping apparatus can quickly and adaptively grip the piston, thereby solving the problem of a complicated operation of gripping the piston in an existing product or in the prior art.

The automatic piston-gripping apparatus can produce a sound in the process of gripping the piston, indicating a (soon) successful gripping, thereby avoiding a faulty operation by the user.

Although specific implementations of the present invention have been described above, those skilled in the art should understand that these are merely examples, and the scope of protection of the present invention is defined by the appended claims. Various alterations or modifications to these implementations can be made by those skilled in the art without departing from the principle and essence of the present invention. However, these alterations and modifications all fall within the scope of protection of the present invention.

### REFERENCE SIGNS LIST

Gripping mechanism 10
Automatic piston-gripping apparatus 100
Holding shank 20
First spring 30
Piston 40
Collet 11
Locking ring 12
First limiting portion 21
Adapter 13
Sleeve 14
Second spring 15
Second limiting portion 22
Third limiting portion 141
Fourth limiting portion 142
Fifth limiting portion 143
Jaw 111
Pusher 50
Protrusion 41
Longitudinal axis 23

1. An automatic piston-gripping apparatus, comprising:
a gripping mechanism;
a holding shank; and
a first spring;
wherein the gripping mechanism is arranged in the holding shank, and the first spring sleeves over the gripping mechanism and is located between the gripping mechanism and the holding shank;
wherein the piston-gripping apparatus is configured for inserting a piston from an end portion of the holding shank that faces a collet of the gripping mechanism;
wherein a locking ring is arranged at a head of the collet;
wherein the end portion of the holding shank is provided with a first limiting portion for positioning the locking ring; and
wherein the piston-gripping apparatus is configured for the collet to extend out of the locking ring when the locking ring moves and/or moved to the first limiting portion, and to automatically grip the piston.

2. The automatic piston-gripping apparatus according to claim 1, wherein:
the gripping mechanism further comprises an adapter, a sleeve, and a second spring;
the adapter is arranged in the sleeve, the collet is mounted at an end portion of the adapter, and the second spring sleeves over the collet and is located between the collet and the sleeve.

3. The automatic piston-gripping apparatus according to claim 2, wherein an inner wall surface of the holding shank is provided with a second limiting portion, an outer wall surface of the sleeve is provided with a third limiting portion, and two ends of the first spring respectively abut against the second limiting portion; and the third limiting portion.

4. The automatic piston-gripping apparatus according to claim 2, wherein an inner wall surface of the sleeve is provided with a fourth limiting portion, and an end portion of the second spring abuts against the fourth limiting portion.

5. The automatic piston-gripping apparatus according to claim 1, wherein the locking ring sleeves over the head of the collet.

6. The automatic piston-gripping apparatus according to claim 1, wherein the head of the collet is a petal-shaped structure.

7. The automatic piston-gripping apparatus according to claim 1, wherein the collet comprises at least two jaws.

8. The automatic piston-gripping apparatus according to claim 7, wherein the collet comprises three jaws, the jaws being circularly arranged.

9. The automatic piston-gripping apparatus according to claim 7, wherein the jaws each have an end portion that is of a circular-arc vane type structure.

10. The automatic piston-gripping apparatus according to claim 7, wherein:
the piston-gripping apparatus is configured for inserting a piston from an end portion of the holding shank along a longitudinal axis;
the collet comprises an elastic material that enables the jaws to move in a radial direction with respect to the longitudinal axis in reaction to a radial force applying on the jaws;
an opening between the jaws opens or closes due the radial movement of the jaws;
the locking ring that is arranged at the head of the collet generates such a radial force on the jaws;
an impact of the radial force generated by the locking ring on the jaws depends on a relative position between the head of the collet and the locking ring.

11. The automatic piston-gripping apparatus according to claim 10, wherein:
the piston-gripping apparatus is configured for inserting a piston from an end portion of the holding shank and for automatically gripping the piston by the head of the collet and the locking ring being arrangeable in a first relative position and in a second relative position;
in the first relative position the impact of the radial force generated by the locking ring on the jaws is such that the opening between the jaws is smaller than an internal gripping hole of the collet; and
in the second relative position, the impact of the radial force generated by the locking ring on the jaws is such that the opening between the jaws is larger than the internal gripping hole of the collet.

12. The automatic piston-gripping apparatus according to claim 1, further comprising the piston.

13. A pipette, comprising the automatic piston-gripping apparatus of claim 1.
